(19) United States
(12) Patent Application Publication
(10) Pub. No.: US 2012/0177953 A1
(43) Pub. Date: Jul. 12, 2012

(54) BATTERIES WITH VARIABLE TERRACE POSITIONS

(75) Inventors: Ramesh C. Bhardwaj, Fremont, CA (US); Taisup Hwang, Santa Clara, CA (US); Richard M. Mank, Sunnyvale, CA (US)

(73) Assignee: APPLE INC., Cupertino, CA (US)

(21) Appl. No.: 12/985,538

(22) Filed: Jan. 6, 2011

(51) Int. Cl. H01M 2/02; H01M 10/42; H01M 10/36

(52) U.S. Cl. 429/7; 29/623.2; 429/94

(57) ABSTRACT

The disclosed embodiments provide a battery cell. The battery cell includes a jelly roll enclosed in a pouch, wherein the jelly roll includes layers which are wound together, including a cathode with an active coating, a separator, and an anode with an active coating. To create the pouch, a first cup and a second cup are formed in a flexible sheet of pouch material based on a terrace position in the battery cell that facilitates efficient use of space within a portable electronic device. The second cup is folded over the first cup, and a terrace seal is formed at the terrace position by sealing the jelly roll in the pouch along a rim of the first and second cups.

### BACKGROUND

1. Field

The disclosed embodiments relate to batteries for portable electronic devices. More specifically, the present embodiments relate to battery cells with variable terrace positions to facilitate efficient use of space within portable electronic devices.

2. Related Art

Portable electronic devices, such as laptop computers, portable media players, and/or mobile phones, typically operate using a rechargeable battery. Furthermore, designs for such batteries often include battery packs that contain battery cells connected together in various series and parallel configurations. For example, a six-cell battery pack of lithium cells may be configured in a three in series, two in parallel (3s2p) configuration. Hence, if a single cell can provide a maximum of 3 amps with a voltage ranging from 2.7 volts to 4.2 volts, then the entire battery pack can have a voltage range of 8.1 volts to 12.6 volts and provide 6 amps of current. The charge in such batteries is typically managed by a circuit, which is commonly known as a protection circuit module (PCM) and/or battery management unit (BMU).

Rechargeable batteries for portable electronic devices often include lithium-polymer batteries, which contain cells packaged in flexible pouches. Such pouches are typically lightweight and inexpensive to manufacture. Moreover, these pouches may be tailored to various cell dimensions, allowing lithium-polymer batteries to be used in space-constrained portable electronic devices such as mobile phones, laptop computers, and/or digital cameras. For example, a lithium-polymer battery cell may achieve a packaging efficiency of 90-95% by enclosing rolled electrodes and electrolyte in an aluminized laminated pouch. Multiple pouches may then be placed side-by-side within a portable electronic device and electrically coupled in series and/or in parallel to form a battery for the portable electronic device.

However, efficient use of space may be limited by the use and arrangement of cells in existing battery pack architectures. In particular, battery packs typically contain rectangular cells of the same capacity, size, and dimensions. The physical arrangement of the cells may additionally mirror the electrical configuration of the cells. For example, a six-cell battery pack may include six lithium-polymer cells of the same size and capacity configured in a 3s2p configuration. Within such a battery pack, two rows of three cells placed side-by-side may be stacked on top of each other; the side-by-side cells may be electrically coupled in a series configuration and the two rows electrically coupled in a parallel configuration. Consequently, the battery pack may require space in a portable electronic device that is at least the length of each cell, twice the thickness of each cell, and three times the width of each cell. Seals along the sides of the cells may take up additional space within the portable electronic device and restrict the placement of other components along the sides of the battery pack.

Hence, the use of portable electronic devices may be facilitated by improvements related to the packaging efficiency, capacity, form factor, cost, design, and/or manufacturing of battery packs containing lithium-polymer battery cells.

### SUMMARY

The disclosed embodiments provide a battery cell. The battery cell includes a jelly roll enclosed in a pouch, wherein the jelly roll includes layers which are wound together, including a cathode with an active coating, a separator, and an anode with an active coating. To create the pouch, a first cup and a second cup are formed in a flexible sheet of pouch material based on a terrace position in the battery cell that facilitates efficient use of space within a portable electronic device. The second cup is folded over the first cup, and a terrace seal is formed at the terrace position by sealing the jelly roll in the pouch along a rim of the first and second cups.

In some embodiments, the battery cell also includes a first conductive tab coupled to the cathode and a second conductive tab coupled to the anode. The first and second conductive tabs are extended through the terrace seal to provide terminals for the battery cell.

In some embodiments, the terrace position facilitates the efficient use of space within the portable electronic device by enabling the vertical placement of a component along a side of the battery cell containing the terrace seal.

In some embodiments, a thickness of the battery cell from an edge of the battery cell to the terrace position is greater than the height of the component.

In some embodiments, the component is at least one of a battery-management unit (BMU) and a bus bar.

In some embodiments, forming the first cup and the second cup in the flexible sheet based on the terrace position of the battery cell involves:
(i) punching a first indentation corresponding to the first cup in the flexible sheet; and
(ii) punching a second indentation corresponding to the second cup in the flexible sheet.

In some embodiments, the first and second indentations have different depths to form the terrace seal at the terrace position.

In some embodiments, the pouch material includes a layer of aluminum and a layer of polypropylene.

### BRIEF DESCRIPTION OF THE FIGURES

FIG. 1 shows a top-down view of a battery cell in accordance with an embodiment.

FIG. 2 shows a cross-sectional view of a battery cell in accordance with an embodiment.

FIG. 3 shows the creation of a pouch for a battery cell from a flexible sheet of pouch material in accordance with an embodiment.

FIG. 4 shows a battery pack in accordance with an embodiment.

FIG. 5 shows a cross-sectional view of a battery pack in accordance with an embodiment.

FIG. 6 shows a flowchart illustrating the process of manufacturing a battery cell in accordance with an embodiment.

FIG. 7 shows a portable electronic device in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments relate to the design of a battery cell, which includes a jelly roll enclosed in a pouch. The jelly roll includes layers which are wound together, including a cathode with an active coating, a separator, and an anode with an active coating. The battery cell also includes a first conductive tab coupled to the cathode and a second conductive tab coupled to the anode. The first and second conductive tabs extend through seals in the pouch to provide terminals for the battery cell.

The battery cell may be manufactured in a way that facilitates efficient use of space within a portable electronic device. To manufacture the battery cell, a flexible sheet of pouch material is obtained, and two cups are formed in the pouch material. The pouch is created by folding one cup over the other cup, and a terrace seal is formed by sealing the jelly roll in the pouch along a rim of the two cups. The terrace position of the terrace seal along the thickness of the battery cell may thus be varied by adjusting the respective depths of the cups in the flexible sheet. In turn, varying of the terrace position may allow a component such as a battery-management unit (BMU) and/or a bus bar to be vertically disposed along a side of the battery cell containing the terrace seal.

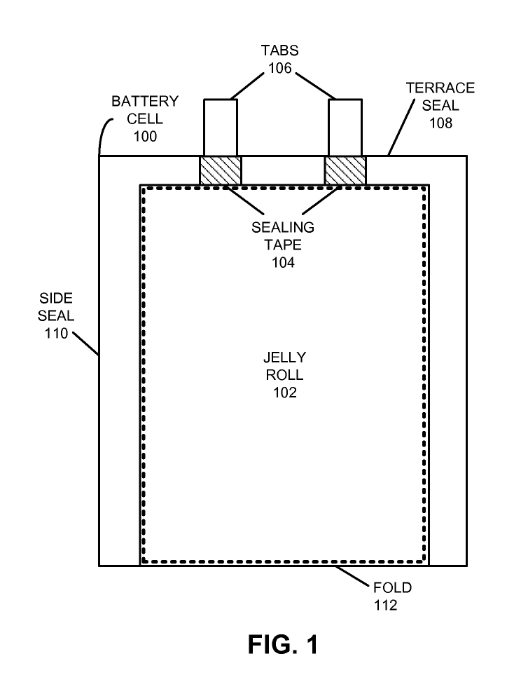

FIG. 1 shows a top-down view of a battery cell 100 in accordance with an embodiment. Battery cell 100 may correspond to a lithium-polymer cell that is used to power a portable electronic device. Battery cell 100 includes a jelly roll 102 containing a number of layers which are wound together, including a cathode with an active coating, a separator, and an anode with an active coating. More specifically, jelly roll 102 may include one strip of cathode material (e.g., aluminum foil coated with a lithium compound) and one strip of anode material (e.g., copper foil coated with carbon) separated by one strip of separator material (e.g., conducting polymer electrolyte). The cathode, anode, and separator layers may then be wound on a mandrel to form a spirally wound structure. Jelly rolls are well known in the art and will not be described further.

During assembly of battery cell 100, jelly roll 102 is enclosed in a flexible pouch, which is formed by folding a flexible sheet along a fold line 112. For example, the flexible sheet may be made of aluminum with a polymer film, such as polypropylene. After the flexible sheet is folded, the flexible sheet can be sealed, for example, by applying heat along a side seal 110 and along a terrace seal 108.

Jelly roll 102 also includes a set of conductive tabs 106 coupled to the cathode and the anode. Conductive tabs 106 may extend through seals in the pouch (for example, formed using sealing tape 104) to provide terminals for battery cell 100. Conductive tabs 106 may then be used to electrically couple battery cell 100 with one or more other battery cells to form a battery pack. For example, the battery pack may be formed by coupling the battery cells in a series, parallel, or series-and-parallel configuration. The coupled cells may be enclosed in a hard case to complete the battery pack, or the coupled cells may be embedded within the enclosure of a portable electronic device, such as a laptop computer, tablet computer, mobile phone, personal digital assistant (PDA), digital camera, and/or portable media player.

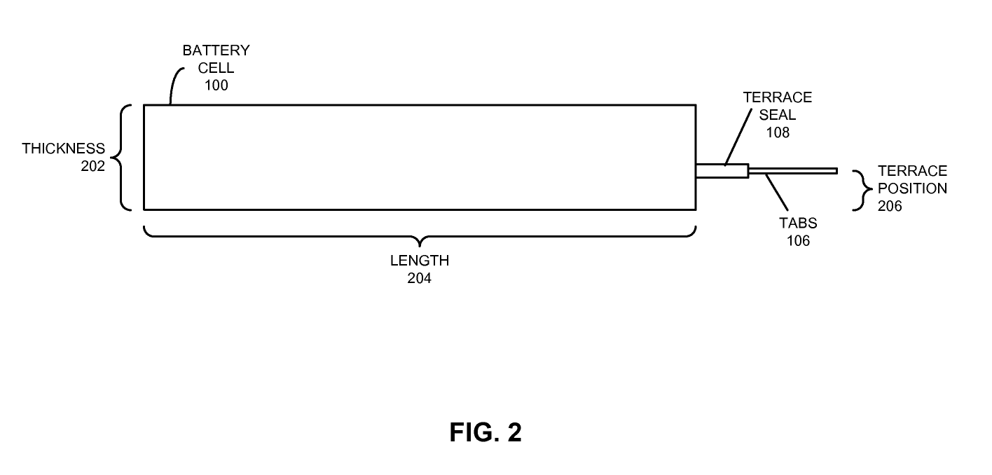

In one or more embodiments, a terrace position of terrace seal 108 is varied to facilitate efficient use of space within the portable electronic device. The terrace position may be based on the relative depths of a first cup and a second cup formed in the flexible sheet. The pouch may then be created by folding the second cup over the first cup, and terrace seal 108 may be formed by sealing jelly roll 102 in the pouch along a rim of the first and second cups. As discussed in further detail below with respect to FIGS. 2-4, such variations to the terrace position of terrace seal 108 may enable the vertical placement of a component such as a battery-management unit (BMU) and/or bus bar along the side of battery cell 100 containing terrace seal 108. In turn, the vertical configuration of the component may facilitate an increase in the size and capacity of battery cell 100 and/or the placement of other components in the portable electronic device.

FIG. 2 shows a cross-sectional view of battery cell 100 in accordance with an embodiment. As shown in FIG. 2, battery cell 100 is associated with a thickness 202 and a length 204. Furthermore, a terrace position 206 of terrace seal 108 may be adjusted along thickness 202 to facilitate efficient use of space inside a portable electronic device powered by battery cell 100.

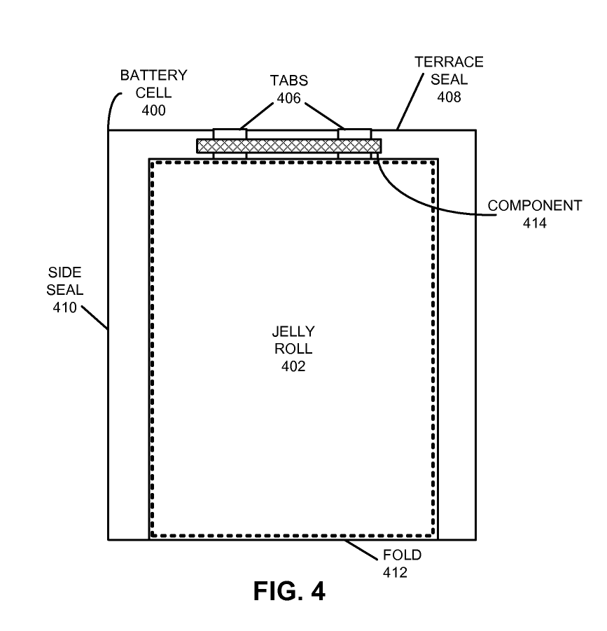

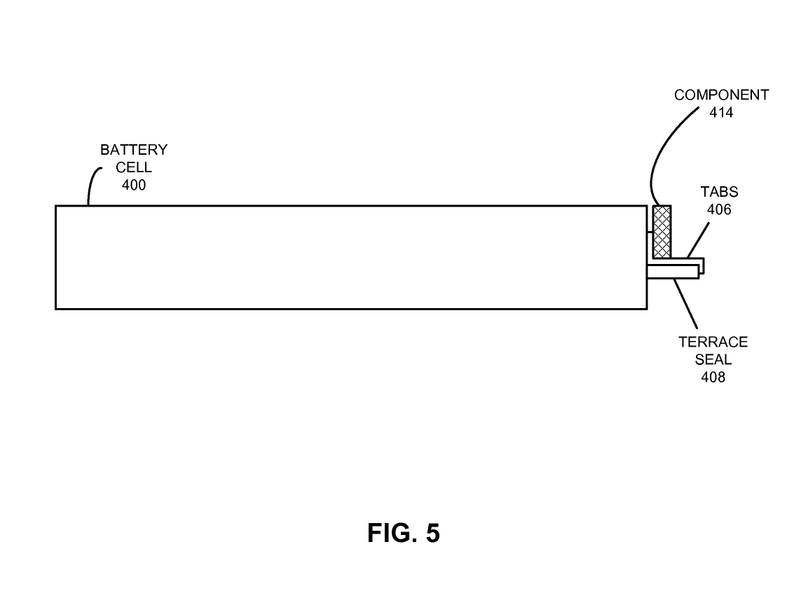

More specifically, terrace position 206 may enable the vertical placement of a component along the side of battery cell 100 containing terrace seal 108. For example, terrace position 206 may be in the bottom half of thickness 202 to allow a battery-management unit (BMU) and/or bus bar to be placed vertically on top of terrace seal 108 instead of horizontally adjacent to terrace seal 108 and/or battery cell 100. Placement of components based on terrace positions in battery cells is discussed in further detail below with respect to FIGS. 4-5.

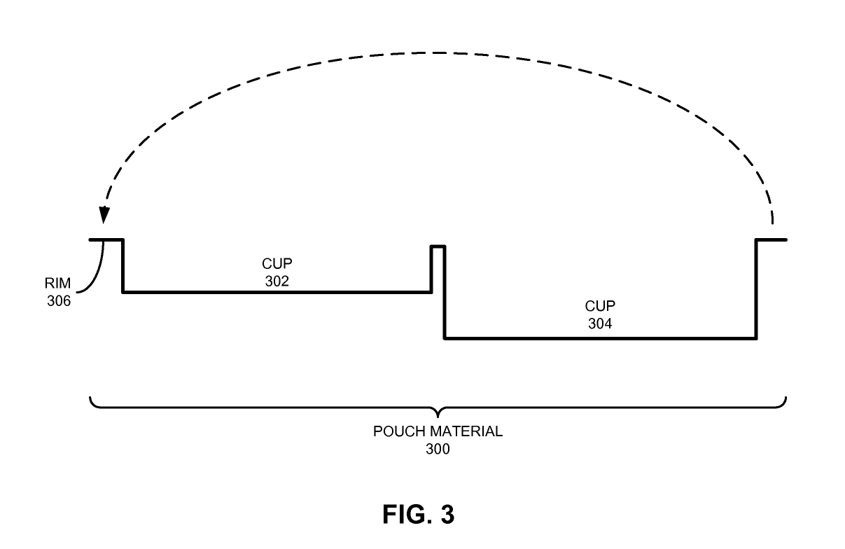

FIG. 3 shows the creation of a pouch for a battery cell (e.g., battery cell 100 of FIG. 1) from a flexible sheet of pouch material 300 in accordance with an embodiment. As mentioned above, pouch material 300 may contain a layer of aluminum and a layer of propylene. To create the pouch, a first cup 302 and a second cup 304 are formed in pouch material 300 based on a terrace position in the battery cell that facilitates efficient use of space within a portable electronic device.

In one or more embodiments, cups 302-304 are formed by punching a first indentation corresponding to the cup 302 in pouch material 300 and punching a second indentation corresponding to cup 304 in pouch material 300. For example, a shallow die may be used to form cup 302, and a deeper die may be used to form cup 302. Cup 304 may then be folded over cup 302, and the terrace seal may be formed at the terrace position by sealing a jelly roll in the pouch along a rim 306 of cups 302-304.

Consequently, cup 302 may correspond to the bottom of the battery cell, and cup 304 may correspond to the top of the battery cell. Moreover, cups 302-304 may have different depths to enable the formation of a terrace seal at a given terrace position in the battery cell. Because cup 302 is shallower than cup 304, the terrace seal may be formed along the bottom half of the battery cell. Alternatively, the terrace position of the terrace seal may be adjusted to be closer to the top half of the battery cell by increasing the relative depth of cup 302 and decreasing the relative depth of cup 304.

FIG. 4 shows a top-down view of a battery pack in accordance with an embodiment. Similarly, FIG. 5 shows a cross-sectional view of the battery pack in accordance with an embodiment. As shown in FIGS. 4-5, the battery pack includes a battery cell 400 that contains a jelly roll 402 enclosed in a flexible pouch along a fold 412, side seal 410, and/or terrace seal 408.

The battery pack also includes a component 414 that is coupled to a set of conductive tabs 406 in battery cell 400. Component 414 may correspond to a BMU that manages use of the battery pack in a portable electronic device such as a mobile phone, PDA, laptop computer, tablet computer, portable media player, digital camera, and/or other type of battery-powered electronic device. For example, the BMU may correspond to an integrated circuit that obtains measurements of voltage, current, temperature, and/or other parameters associated with battery cell 400. The BMU may use the measurements to assess the state of charge, capacity, and/or health of battery cell 400. The BMU may also adjust the charging and/or discharging of battery cell 400 based on the assessed state of charge, capacity, and/or health. Alternatively, component 414 may correspond to a bus bar and/or other electrical component that connects battery cell 400 to a BMU and/or to other battery cells in the battery pack.

To assemble the battery pack, component 414 may be initially placed next to terrace seal 408 and coupled to tabs 406. Component 414 may then be folded up against the side of battery cell 400 and placed on top of terrace seal 408 to reflect the configuration shown in FIGS. 4-5.

In one or more embodiments, the thickness of battery cell 400 and/or the terrace position of terrace seal 408 allow for the vertical placement of component 414 on top of terrace seal 408 and along the side of battery cell 400 containing terrace seal 408. First, one or more dimensions of battery cell 400 may be increased to reduce the number of battery cells used by the battery pack. For example, battery cell 400 may be designed to replace two stacked battery cells in a thin portable electronic device such as a portable media player, mobile phone, and/or tablet computer. As a result, battery cell 400 may be twice as thick (e.g., 10 mm) as each battery cell (e.g., 5 mm) in the stacked configuration.

Next, the positioning of terrace seal 408 along the increased thickness of battery cell 400 may facilitate the vertical placement of component 414 on top of terrace seal 408 instead of the horizontal placement of component 414 next to terrace seal 408. For example, a terrace position along the bottom third of a 10-mm-thick battery cell 400 may allow a 6-mm-long, 2-mm-thick BMU to be vertically disposed on top of a 4-mm terrace seal 408 without protruding past the top of battery cell 400 or the edge of terrace seal 408. Terrace seal 408 may thus be positioned so that the thickness of battery cell 400 from the top edge of battery cell 400 to the terrace position of terrace seal 408 is greater than the height of component 414.

Because component 414 resides within the dimensions of battery cell 400 and does not occupy space outside of battery cell 400, the battery pack of FIGS. 4-5 may represent a space savings over battery packs in which BMUs and/or bus bars are placed next to battery cells. In turn, the space savings may enable an increase in the size and capacity of battery cell 400 and/or the placement of other components in the space next to terrace seal 408. In other words, the battery pack may facilitate the efficient use of space within the portable electronic device.

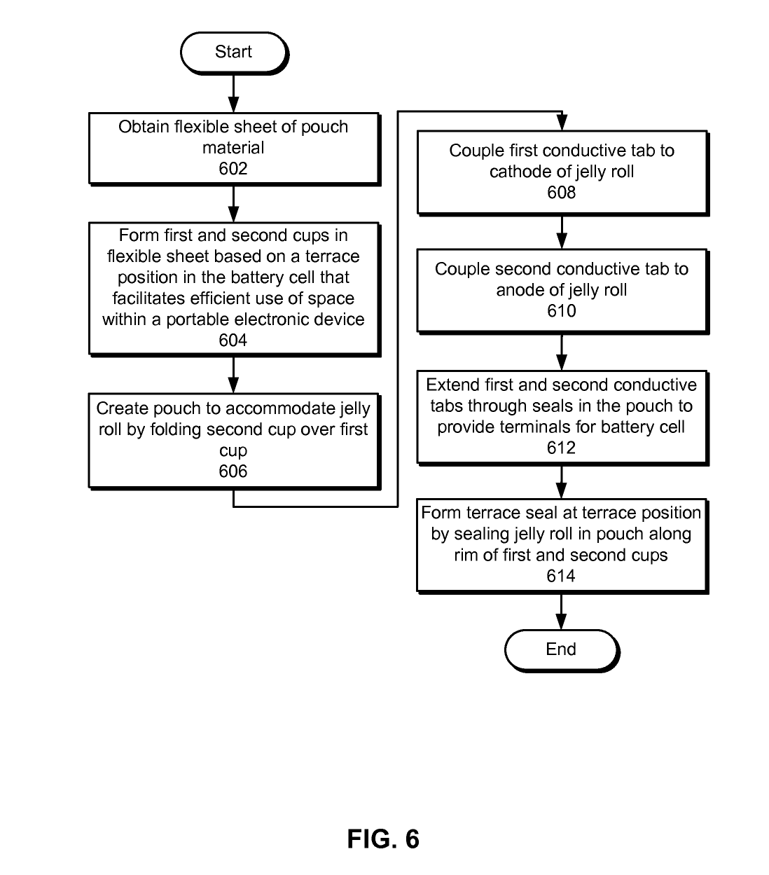

FIG. 6 shows a flowchart illustrating the process of manufacturing a battery cell in accordance with an embodiment. In one or more embodiments, one or more of the steps may be omitted, repeated, and/or performed in a different order. Accordingly, the specific arrangement of steps shown in FIG. 6 should not be construed as limiting the scope of the embodiments.

Initially, a flexible sheet of pouch material is obtained (operation 602). The pouch material may include a layer of aluminum and a layer of propylene. Next, a first cup and a second cup are formed in the flexible sheet based on a terrace position in the battery cell that facilitates efficient use of space within a portable electronic device (operation 604). To form the cups, two indentations may be punched in the flexible sheet. In addition, the first and second indentations may have different depths to form the terrace seal at the terrace position. For example, the first cup may be shallower than the second cup to enable the formation of the terrace seal along the bottom of the battery cell. The second cup is then folded over the first cup to create a pouch to accommodate a jelly roll (operation 606) in the battery cell.

A first conductive tab is coupled to the cathode of the jelly roll (operation 608), and a second conductive tab is coupled to the anode of the jelly roll (operation 610). The first and second conductive tabs are extended through seals in the pouch to provide terminals for the battery cell (operation 612). Finally, the terrace seal is formed at the terrace position by sealing the jelly roll in the pouch along the rim of the first and second cups (operation 614). The adjustability of the terrace position during manufacturing of the battery cell may enable the vertical placement of a component along a side of the battery cell containing the terrace seal. For example, the terrace seal may be positioned so that a thickness of the battery cell from an edge of the battery cell to the terrace position is greater than the height of the component, thus allowing the component to be vertically disposed on top of the terrace seal without protruding past the edge of the battery cell.

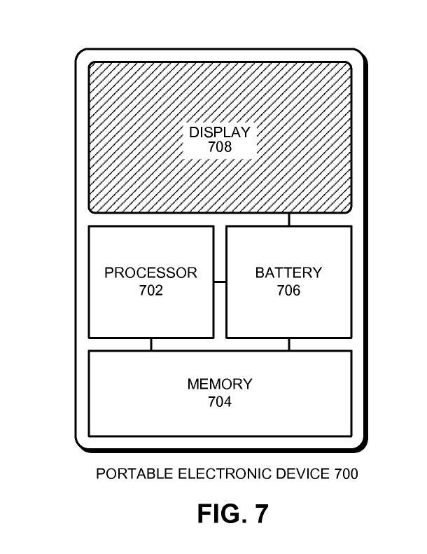

The above-described rechargeable battery cell can generally be used in any type of electronic device. For example, FIG. 7 illustrates a portable electronic device 700 which includes a processor 702, a memory 704 and a display 708, which are all powered by a battery 706. Portable electronic device 700 may correspond to a laptop computer, mobile phone, PDA, portable media player, digital camera, and/or other type of battery-powered electronic device. Battery 706 may correspond to a battery pack that includes one or more battery cells. Each battery cell may include a jelly roll sealed in a pouch along a terrace seal. The battery pack may also include a BMU disposed vertically along a side of the battery cell containing the terrace seal to facilitate efficient use of space within a portable electronic device.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method for manufacturing a battery cell, comprising:
obtaining a flexible sheet of pouch material;
forming a first cup and a second cup in the flexible sheet based on a terrace position in the battery cell that facilitates efficient use of space within a portable electronic device;
creating a pouch to accommodate a jelly roll by folding the second cup over the first cup; and
forming a terrace seal at the terrace position by sealing the jelly roll in the pouch along a rim of the first and second cups.

2. The method of claim 1, further comprising:
coupling a first conductive tab to the cathode of the jelly roll;
coupling a second conductive tab to the anode of the jelly roll; and
extending the first and second conductive tabs through the terrace seal to provide terminals for the battery cell.

3. The method of claim 1, wherein the terrace position facilitates the efficient use of space within the portable electronic device by enabling the vertical placement of a component along a side of the battery cell containing the terrace seal.

4. The method of claim 3, wherein a thickness of the battery cell from an edge of the battery cell to the terrace position is greater than the height of the component.

5. The method of claim 3, wherein the component is at least one of a battery-management unit (BMU) and a bus bar.

6. The method of claim 1, wherein forming the first cup and the second cup in the flexible sheet based on the terrace position of the battery cell involves:
punching a first indentation corresponding to the first cup in the flexible sheet; and
punching a second indentation corresponding to the second cup in the flexible sheet.

7. The method of claim 6, wherein the first and second indentations have different depths to form the terrace seal at the terrace position.

8. The method of claim 1, wherein the pouch material comprises:
a layer of aluminum; and
a layer of polypropylene.

9. A battery pack, comprising:
a battery cell, comprising:
a jelly roll comprising layers which are wound together, including a cathode with an active coating, a separator, and an anode with an active coating; and
a pouch enclosing the battery cell, wherein the jelly roll is sealed in the pouch along a terrace seal; and
a battery-management unit (BMU) disposed vertically along a side of the battery cell containing the terrace seal to facilitate efficient use of space within a portable electronic device.

10. The battery pack of claim 9, further comprising:
a first conductive tab coupled to the cathode; and
a second conductive tab coupled to the anode,
wherein the first and second conductive tabs extend through the terrace seal to provide terminals for the battery cell, and
wherein the first and second conductive tabs are additionally coupled to the BMU.

11. The battery pack of claim 9, wherein a thickness of the battery cell from an edge of the battery cell to a terrace position of the terrace seal is greater than the height of the BMU.

12. The battery pack of claim 9, wherein the pouch comprises:
a first cup in a flexible sheet of pouch material; and
a second cup in the flexible sheet,
wherein the pouch is formed by folding the second cup over the first cup.

13. The battery pack of claim 12,
wherein the first cup is formed by punching a first indentation in the pouch material, and
wherein the second cup is formed by punching a second indentation in the pouch material.

14. The battery pack of claim 13, wherein the first and second indentations have different depths to form the terrace seal at a terrace position that facilitates efficient use of space within the portable electronic device.

15. The battery pack of claim 8, wherein the pouch comprises:
a layer of aluminum; and
a layer of polypropylene.

16. A portable electronic device, comprising:
a set of components powered by a battery pack; and
the battery pack, comprising:
a battery cell, comprising:
a jelly roll comprising layers which are wound together, including a cathode with an active coating, a separator, and an anode with an active coating; and
a pouch enclosing the battery cell, wherein the jelly roll is sealed in the pouch along a terrace seal; and
a component disposed vertically along a side of the battery cell containing the terrace seal to facilitate efficient use of space within the portable electronic device.

17. The portable electronic device of claim 16, wherein the battery pack further comprises:
a first conductive tab coupled to the cathode; and
a second conductive tab coupled to the anode,
wherein the first and second conductive tabs extend through the terrace seal to provide terminals for the battery cell, and
wherein the first and second conductive tabs are additionally coupled to the component.

18. The portable electronic device of claim 17, wherein the component is at least one of a battery-management unit (BMU) and a bus bar.

19. The portable electronic device of claim 16, wherein a thickness of the battery cell from an edge of the battery cell to the terrace position is greater than the height of the component.

20. The portable electronic device of claim 19, wherein the pouch comprises:
a first cup in a flexible sheet of pouch material; and
a second cup in the flexible sheet,
wherein the pouch is formed by folding the second cup over the first cup.

21. The portable electronic device of claim 20,
wherein the first cup is formed by punching a first indentation in the pouch material, and
wherein the second cup is formed by punching a second indentation in the pouch material.

22. The portable electronic device of claim 21, wherein the first and second indentations have different depths to form the terrace seal at a terrace position that facilitates efficient use of space within the portable electronic device.
